(19) United States
(12) Patent Application Publication
(10) Pub. No.: US 2025/0252953 A1
(43) Pub. Date: Aug. 7, 2025

(54) INTERACTIVE EDUCATION DEVICE AND METHOD FOR GUIDANCE USING ARTIFICIAL INTELLIGENCE

(71) Applicant: Ashok JAISWAL, Hong Kong (HK)

(72) Inventor: Ashok JAISWAL, Hong Kong (HK)

(21) Appl. No.: 18/789,925

(22) Filed: Jul. 31, 2024

(30) Foreign Application Priority Data
Feb. 1, 2024 (HK) 32024086404.3

(51) Int. Cl. G10L 15/22; G06F 3/02; G10L 13/02; G10L 15/183; H04W 4/80

(52) U.S. Cl. CPC G10L 15/22; G06F 3/02; G10L 13/02; G10L 15/183; H04W 4/80

(57) ABSTRACT

Disclosed is a device and a method for interactive guidance. The device includes sensor(s), input device(s), and output device(s) configured on the body of the device to detect and receive input from the user, and generate output, respectively. The input device(s) may include touch-sensitive buttons, a mic, and a Near Field Communication (NFC) reader. The sensor(s) and output device(s) may include an accelerometer and a speaker, respectively. The device may receive the input from the user as text or voice, converts the input (voice) into text through a contextual search using Large Language Model based approaches, simulates conversation for interactive guidance, and generates an output via the output device(s) as text or voice. The device may deactivate to a power saving mode when idle for a predetermined time period.

### CROSS-REFERENCE TO RELATED APPLICATIONS

Not applicable.

### BACKGROUND OF THE INVENTION

The present invention disclosure relates to the field of guidance tools. In particular, the present disclosure relates to a device and a method for interactive guidance.

Background description includes information that may be useful in understanding the present disclosure. It is not an admission that any of the information provided herein is prior art or relevant to the presently claimed disclosure, or that any publication specifically or implicitly referenced is prior art.

Learning in the early years of childhood has a crucial impact on the overall intellectual and emotional development of a person. Toys form an integral part of childhood. Consequently, many guidance tools for teaching and imparting knowledge exist that include toys.

Some of the guidance (teaching) tools include toys which play pre-recorded content, toys with remote messaging applications, educational mobile apps, Internet of Things (IoT) Toys, and personalized voice assistants for children. Learning especially in the early years of childhood is through interaction with people and surroundings. The existing solutions for guidance lack interactive components that enable learning. Children may also easily lose interest in the limited interactions of the toys, which restricts their engagement and learning potential. With the advances in Generative Artificial Intelligence (AI), especially Large Language Models (LLMs) generating original content to simulate human-like conversation has become a possibility. With the advances in AI, the following tasks can be automatically performed through computers. These tasks include accurate conversion from voice (speech) to text and text to voice, translation of text from one language to another language, voice conversion from one person's voice (source) to another person's voice (target).

Therefore, a solution for interactive guidance is needed which utilizes the current advances in AI as guidance for modern education.

While educational mobile apps nowadays may offer learning opportunities, they often require screen time and limit physical play time. They lack the tactile engagement and personalized interactions that are provided by physical toys, which do not facilitate interactive learning and emotional bonding. Therefore, a merger of digital technology with tangible play toys is much needed to stimulate cognitive and sensory development.

U.S. Pat. No. 11,663,182 discloses systems, methods and apparatuses for an artificial intelligence (AI) toy with improved conversational dialogue and personality development. The AI toy determines responses to stimuli based on user profiles and personality profiles that are developed through user interaction and external media inputs. Natural language processing (NLP) and other semantic interaction processing are paired with the profiles to develop AI personality and conversational ability. However, the AI toy is merely providing voice-based question-answer interactions, which may lack interactive learning and play.

China Patent No. 2717504Y discloses an interdynamic toy. A camera device and a playing device are arranged in a toy body, which enables a user to be able to record sounds and images that the user wants to play optionally. Different control messages are input to a controlling and processing unit by sensors that are distributed around the toy body, and the playing device is stated to play the relative echo actions that are recorded preliminarily by the controlling and processing unit, which creates the effect of interaction. The toy body is also provided with a signal comparison processing unit that can analyze the signals which are input by the comparison and execute a specific echo to strengthen interaction and the learning function of languages. Although the device allows parents to record their voice in advance to be played later, this may provide a limited selection of pre-recorded stories or voices, therefore restricting children's engagement and learning potential. Therefore, there is a need to provide real-time engagement and adaptability based on children's interests. There is also a need to provide a method to enhance children's creativity and family connections which is neither disclosed in the aforementioned prior art document nor a common knowledge in the field.

China Patent No. 215202006U discloses a robot device capable of customizing and simulating human voice, which belongs to the technical field of intelligent robots and comprises a CPU, wherein the CPU is respectively connected with a distance sensor module, a light sensor module, a temperature sensor module, a voice playing module, a power management module, an LED, a storage module and a voice synthesis module, the voice synthesis module is connected with a voice recognition module for voice recognition, the voice recognition module is connected with a network communication module, the voice recognition module is connected with a voice acquisition module through the network communication module, the utility model discloses pre-process the acquired background sound by a toy terminal through a WIFI or 5G bridge, and then, the depth recognition and analysis of the human voice are realized by utilizing the cloud voice processing server cluster capacity of the voice recognition module, the customization of the human voice is realized, and text information is played for children by synthesizing the sound which is highly similar to the sound of parents through utilizing the voiceprint characteristic information of the parents. However, the device merely focuses on stimulating the human voice and lacks natural conversation between the user and the device. Therefore, there is a need to provide a personalized and emotionally resonant learning experience that enhances familial connections through a natural conversation.

The technical solution of combining cutting-edge technologies, such as artificial intelligence, the Internet of Things, and emotional resonance, with teaching methods to shape a new learning approach, deeply and innovatively fostering children's development and strengthening family relationships is needed to result in significant technological effects.

### SUMMARY OF THE INVENTION

Some of the objects of the present disclosure, which at least one embodiment herein satisfies are as listed below.

An objective of the present disclosure is to provide a device and a method for generating interactive guidance.

Another objective of the present disclosure is to incorporate the advances in generative artificial intelligence (AI) to simulate interactive context specific conversations associated with guidance, provide personalized conversations and storytelling in the voices of parents or caregivers, foster emotional bonds, enhance family connections, and enrich educational interactions.

It is also an objective of the present invention to provide an interactive learning toy system and method that integrate NFC interaction to enable intuitive and tactile topic selection, thus guiding children through educational journeys tailored to their interests.

It is also a further objective of the present invention to provide a cloud-based interactive learning toy system and method for allowing users to send personalized messages, stories and songs, thus enhancing the educational and emotional value of the toy.

Accordingly, these objectives may be achieved by following the teachings of the present invention. The present invention relates device for interactive guidance, the device comprising: a body; one or more input devices for receiving an input from a user, wherein the one or more input devices are configured with the body; one or more output devices for generating an output from the device, wherein the one or more output devices are configured with the body; one or more sensors to detect the input from the user, wherein the one or more sensors are configured with the body; at least one processor communicatively coupled with one or more computing devices, wherein one or more users operate the computing devices and are connected to the device via a network; and a memory operatively coupled with the at least one processor, wherein said memory stores executable instructions which when executed by the at least one processor, causes the at least one processor to: activate, the device, to a functioning mode when the input is detected by the one or more input devices and one or more sensors; receive, the input, via the one or more input devices; determine, the output, via one or more approaches, based on the input; and generate, the output, via the one or more output devices.

### BRIEF DESCRIPTION OF DRAWINGS

The accompanying drawings are included to provide a further understanding of the present disclosure, and are incorporated in, and constitute a part of this specification. The drawings illustrate exemplary embodiments of the present disclosure, and together with the description, serve to explain the principles of the present disclosure.

In the figures, similar components, and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an example device for interactive guidance, in accordance with an embodiment of the present disclosure.

FIG. 2 illustrates an example flow diagram for generating an output for an input from a user by an example device for interactive guidance, in accordance with an embodiment of the present disclosure.

FIG. 3 illustrates an example flow diagram for multi-modal output generation based on a multi-modal input from a user which includes language translation performed by the device for interactive guidance, in accordance with an embodiment of the present disclosure.

FIG. 4 illustrates an example device for interactive guidance with structural and functional components, in accordance with an embodiment of the present disclosure.

FIG. 5 illustrates an example method for interactive guidance, in accordance with an embodiment of the present disclosure.

### DETAILED DESCRIPTION OF THE INVENTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

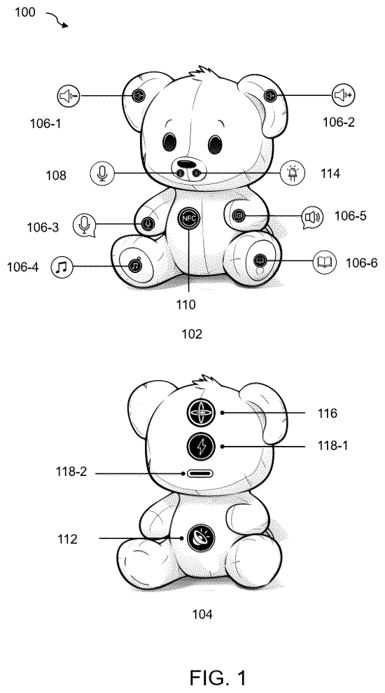

Various aspects of the present disclosure are described with respect to FIG. 1 to FIG. 5.

The present disclosure relates to the field of guidance tools. In particular, the present disclosure relates to a device and a method for interactive guidance.

In an aspect, the present disclosure relates to a device 100 for interactive guidance. The device 100 includes a body. The device 100 may include one or more input devices for receiving an input from a user, wherein the one or more input devices are configured with the body. The device 100 may include one or more output devices for generating an output from the device 100, wherein the one or more output devices are configured with the body. The device 100 includes one or more sensors to detect the input from the user, wherein the one or more sensors are configured with the body. Further, the device 100 includes at least one processor communicatively coupled with one or more computing devices, wherein one or more users operate the computing devices connected to the device 100 via a network. The device 100 includes a memory operatively coupled with the at least one processor, wherein said memory stores executable instructions. When the executable instructions are executed by the at least one processor, the at least one processor performs the following steps. The at least one processor activates the device 100 to a functioning mode when the input is detected by the one or more input devices and one or more sensors. The at least one processor receives the input, via the one or more input devices. The at least one processor determines the output via one or more approaches based on the input. The at least one processor generates the output via the one or more output devices.

FIG. 1 illustrates an example device 100 for interactive guidance, in accordance with an embodiment of the present disclosure. In an exemplary embodiment, the device for interactive guidance may be a device for teaching children of 2 years to 12 years of age without the supervision of adults. Referring to FIG. 1, in an embodiment, the body of the device 100 may be a toy, that may have a name like Gappu or HarmonyHeart or even set by the child or parent through voice prompt or by coupled devices like computer or smartphone. The body of the device 100 may have shapes like a plush teddy bear as shown or be made of plastic, metal, rubber, wood or any other material. Front view 102 and back view 104 of the device 100 are shown in FIG. 1. In an exemplary embodiment, the body of the device 100 may be of a shape and texture that is safe for children and provides emotional comfort to children.

In an embodiment, the one or more input devices may include at least one of one or more touch-sensitive buttons (numbered 106-1, 106-2, . . . , 106-6 in the figure, and jointly or individually referred to as 106), a mic 108, and a Near field Communication (NFC) reader 110. In an exemplary embodiment, the touch-sensitive buttons 106 may include at least one of a button to decrease volume 106-1, a button to increase volume 106-2, a button to record audio 106-3, a button to play audio 106-4, a button to listen to messages 106-5, and a button to read books 106-6.

In an embodiment, the one or more output devices may include at least a speaker 112 for generating a voice-based output. In an exemplary embodiment, the output devices may include one or more light emitting diodes (LED) 114. In an embodiment, the one or more sensors to detect the input from the user may include an accelerometer 116 to detect a movement in the device 100.

In an embodiment, the device 100 may include at least one of one or more means for charging one or more batteries powering the device 100 and one or more output modules to modulate the output, where the one or more means for charging the one or more batteries, the one or more batteries, and the one or more output modules are configured with the body 100. In an exemplary embodiment, the one or more output modules may include a volume control. In an exemplary embodiment, the charging means may include a wireless charging mechanism via a wireless charging 118-1 or a wired charging mechanism via a USB-C charging port (USB stands for Universal Serial Bus) 118-2.

In an embodiment, the device 100 activates to a functioning mode when a movement associated with the device 100 is detected by the accelerometer 116 or touch-sensitive button(s) 106 are pressed. In an embodiment, the device 100 may de-activate to a non-functioning mode (power saving mode) when the device 100 is idle for a pre-determined time period.

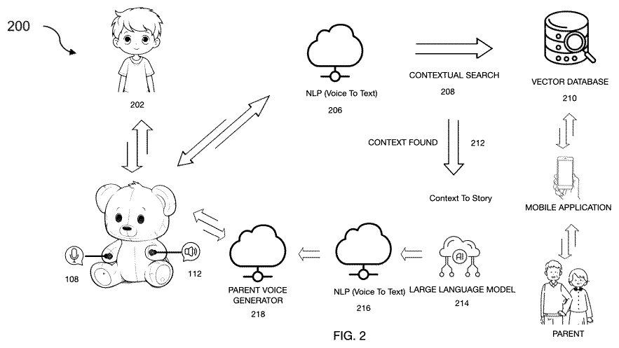

In an embodiment, the device 100 performs the following steps. FIG. 2 illustrates an example flow diagram 200 for output generation for an input from a user by an example device for interactive guidance, in accordance with an embodiment of the present disclosure. The device 100 may receive the input via the one or more input devices. In an exemplary embodiment, the input from the user 202 may be received via a mic 108 as speech and the input may be converted to text through Natural Language Processing (NLP) 206. In an exemplary embodiment, the input may be received via one or more computing devices communicatively coupled to the device 100 via a network. In an exemplary embodiment, the input may be received via NFC reader using one or more NFC tags encoding unique identifiers to initiate topic-specific interaction. The device 100 may determine the output via one or more approaches based on the one or more inputs. In an embodiment, the one or more approaches comprise one or more large language model (LLM) 214 based approaches. In an embodiment, the output is determined through a contextual search 212 where a database 210 is searched using Large Language Models (LLMs) 214. For example, the input from the user may be a question in the context of a story from a given list of stories. The contextual search 212 is search where the search space is constrained or bounded to the content of the story 208. In an embodiment, the device 100 for interactive guidance may be an Internet of Things (IoT) device or an application running on a smartphone or a website accessible via computer or smartphone connected to a server via a network, and the AI based tasks (voice to text and text to voice conversions, and language translations) and content determination or generation through LLM 214 based techniques is being done on a server.

In an embodiment, the device 100 may generate the output via the one or more output devices. In an exemplary embodiment, the output of the LLM 214 based approaches in the textual form may be converted to voice 216 and may be generated via a speaker 112. In an embodiment, the voice-based output is based on the voice 218 of at least one of a parent, a teacher, and a caregiver. In an exemplary embodiment, for generating the voice-based output recorded parental voice (speech) database may be used by the device 100.

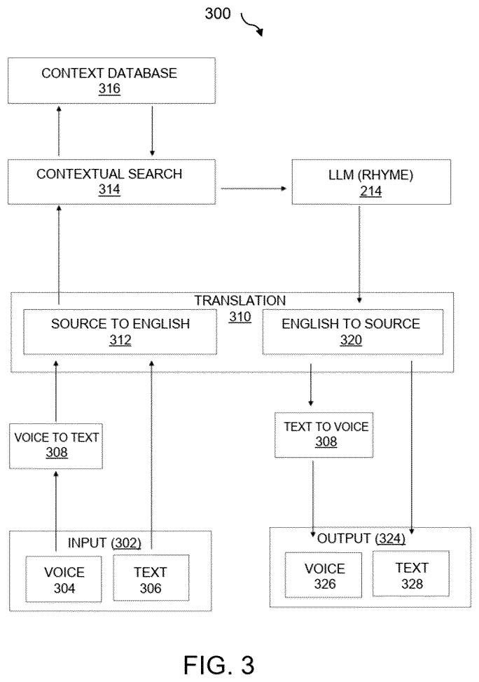

FIG. 3 illustrates an example flow diagram 300 for multi-modal output generation based on a multi-modal input which includes language translation performed by the device for interactive guidance, in accordance with an embodiment of the present disclosure. Referring to FIG. 3, in an embodiment, the multi-modal input 302 from the user may include at least one of a voice (speech) 304 and a text 306. In the case of voice 304 based input, conversion from voice to text 308 may be performed. In an exemplary embodiment, the input from the user may be given in multiple languages, and a translation 310 may be performed to convert the source language text to English text 312. Based on the English textual input a contextual search 314 may be performed in the context database 316 using LLM 214 based approaches. For example, the contextual search may be based on a particular children's rhyme. In an exemplary embodiment, the contextual search 314 may generate a text-based output in English which may be translated to the source language 320 in which the input from the user was receive by the device 100. In an embodiment, the textual output may be converted to voice (speech) 322. The output 324 to the user may be voice 326 or text 328). In an embodiment, the device 100 is connected to a cloud server for establishing a connection to a cloud-based platform. New content (stories, rhymes etc.) may be made available to the user(s) of the device 100 from a cloud server(s) via the network.

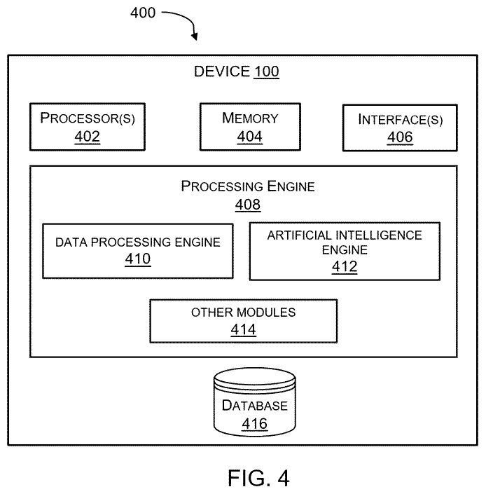

FIG. 4 illustrates an example device for interactive guidance with structural and functional components, in accordance with an embodiment of the present disclosure. Referring to FIG. 4, the device 100 may include at least one processor 402 that may be implemented as one or more microprocessors, microcomputers, microcontrollers, digital signal processors, central processing units, logic circuitries, and/or any devices that process data based on operational instructions. Among other capabilities, the processor(s) 402 may be configured to fetch and execute computer-readable instructions stored in a memory 404 of the device 100. The memory 404 may be configured to store one or more computer-readable instructions or routines in a non-transitory computer readable storage medium, which may be fetched and executed to create or share data packets over a network service. The memory 404 may comprise any non-transitory storage device including, for example, volatile memory such as random-access memory (RAM), or non-volatile memory such as erasable programmable read only memory (EPROM), flash memory, and the like.

In an embodiment, the device 100 may include an interface(s) 406. The interface(s) 406 may include a variety of interfaces, for example, interfaces for data input and output devices, referred to as I/O devices, storage devices, and the like. The interface(s) 406 may facilitate communication to or from the device 100. The interface(s) 406 may also provide a communication pathway for one or more components of the device 100. Examples of such components include, but are not limited to, a processing unit or engine(s) 408 and a local database 416. In an embodiment, the local database 416 may be separate from the device 100.

In an embodiment, the processing engine(s) 408 may be implemented as a combination of hardware and programming (for example, programmable instructions) to implement one or more functionalities of the processing engine(s) 408. In examples described herein, such combinations of hardware and programming may be implemented in several different ways. For example, the programming for the processing engine(s) 408 may be processor-executable instructions stored on a non-transitory machine-readable storage medium and the hardware for the processing engine(s) 408 may comprise a processing resource (for example, one or more processors), to execute such instructions. In the present examples, the machine-readable storage medium may store instructions that, when executed by the processing resource, implement the processing engine(s) 408. In such examples, the device 100 may include the machine-readable storage medium storing the instructions and the processing resource to execute the instructions, or the machine-readable storage medium may be separate but accessible to the device 100 and the processing resource. In other examples, the processing engine(s) 408 may be implemented by electronic circuitry.

In an embodiment, the processing engine 408 may include a data processing engine 410, an Artificial Intelligence (AI) engine 412, and other modules 414. The processor(s) 402 via the data processing engine 410 may activate the device 100 to a functioning mode when the input from the user is detected by the one or more sensors and the one or more input devices. The processor(s) 402 via the data processing engine 410 may receive the input from the user, via the one or more input devices. The processor(s) 402 via the AI engine 412 may generate the output via one or more LLM 214 based approaches based on the one or more inputs. In an exemplary embodiment, the processor(s) 402 via the AI Engine 412 may perform various tasks which may include voice to text conversion 308, text to voice conversion 322, translation from one language text to another language text 310 shown in FIG. 3. The processor(s) 402 may generate the output via the one or more output devices. The other modules 416 may implement the other functionalities of the device 100.

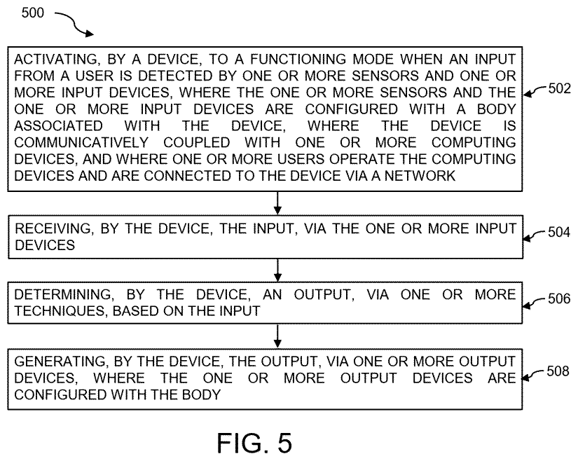

In an aspect, the present disclosure relates to method for interactive guidance. FIG. 5 illustrates an example method 500 for interactive guidance, in accordance with an embodiment of the present disclosure. The device 100 referred to in the method 500 is similar to device 100 shown in FIG. 1. The method 500 may include the following steps. At step 502, a device 100 may activate to a functioning mode when an input from a user is detected by one or more sensors and one or more input devices, where the one or more sensors and the one or more input devices are configured with a body associated with the device 100, where the device 100 is communicatively coupled with one or more computing devices, and where one or more users operate the computing devices and are connected to the device 100 via a network. At step 504, the device 100 may receive the input via the one or more input devices. At step 506, the device 100 may determine an output via one or more approaches based on the input. At step 508, the device 100 may generate the output via one or more output devices, where the one or more output devices are configured with the body.

The device 100 in the present invention provides LLM 214 conversations wherein the use of LLM 214 technology could simulate conversations and storytelling in the voices of parents of caregivers. This feature offers a personalized and emotionally resonant experience, significantly enhancing familial connections and enriching educational interactions.

The device 100 in the present invention provides topic-driven NFC interaction wherein the NFC tags could be in heart-shaped, each representing a distinct educational topic, interacting with a magnetic NFC reader. This feature enables intuitive and tactile topic selection, guiding children through educational journeys tailored to their interests.

The device 100 in the present invention provides dynamic AI-driven conversations wherein the implementation of touch-sensitive buttons could facilitate dynamic AI-driven conversations, leveraging LLM 214 AI. This interaction mode engages children in thought-provoking dialogues, promoting language development and cognitive growth.

The device 100 in the present invention provides an integration of CloudConnect WiFi Module for seamless content exchange between the device 100 and a cloud-based platform. This capability empowers parents to send personalized messages, stories, and songs, enhancing the educational and emotional value of the device 100.

The device 100 in the present invention could enhance family bonding by utilization of recorded parental voices within LLM 214 AI interactions constitutes a distinct and innovative aspect. This feature creates a sense of familiarity, reinforcing family bonds and emotional well-being during play and learning.

The device 100 in the present invention provides a comprehensive sensor integration by the combination of the accelerometer for wake-up activation, Qi charging pad for wireless charging, and strategically placed touch-sensitive buttons. This approach ensures a user-friendly and engaging experience for children.

The device 100 in the present invention provides educational focus encompassing language development, mental well-being, mindfulness, cultural awareness, and STEAM subjects, along with the ability to customize interactions. This provides unique contribution to the interactive educational toy landscape.

1. A device for interactive guidance, the device comprising:
a body;
one or more input devices for receiving an input from a user, wherein the one or more input devices are configured with the body;
one or more output devices for generating an output from the device, wherein the one or more output devices are configured with the body;
one or more sensors to detect the input from the user, wherein the one or more sensors are configured with the body;
at least one processor communicatively coupled with one or more computing devices, wherein one or more users operate the computing devices and are connected to the device via a network; and
a memory operatively coupled with the at least one processor, wherein said memory stores executable instructions which when executed by the at least one processor, causes the at least one processor to:
activate, the device, to a functioning mode when the input is detected by the one or more input devices and one or more sensors;
receive, the input, via the one or more input devices;
determine, the output, via one or more approaches, based on the input; and
generate, the output, via the one or more output devices.

2. The device as claimed in claim 1, wherein the one or more input devices comprise at least one of: one or more touch-sensitive buttons, a mic, and a Near field Communication reader.

3. The device as claimed in claim 1, wherein the one or more output devices comprise at least a speaker for generating a voice-based output.

4. The device as claimed in claim 1, comprising at least one of: one or more means for charging one or more batteries powering the device and one or more output modules to modulate the output, wherein the one or more means for charging the one or more batteries, the one or more batteries, and the one or more output modules are configured with the body.

5. The device as claimed in claim 3, wherein the voice-based output is based on the voice of at least one of: a parent, a teacher, and a caregiver.

6. The device as claimed in claim 1, wherein the one or more approaches comprise one or more large language model based approaches.

7. The device as claimed in claim 1, wherein the device is connected to a cloud server for establishing a connection to a cloud-based platform.

8. A method for interactive teaching, the method comprising:
activating, by at least one processor associated with a device, the device, to a functioning mode when an input from a user is detected by one or more sensors and one or more input devices, wherein the one or more sensors and the one or more input devices are configured with a body associated with the device, wherein the at least one processor is communicatively coupled with one or more computing devices, and wherein one or more users operate the computing devices and are connected to the device via a network;
receiving, by the at least one processor, the input, via the one or more input devices;
determining, by the at least one processor, an output, via one or more approaches, based on the input; and
generating, by the at least one processor, the output, via one or more output devices,
wherein the one or more output devices are configured with the body.

9. The method as claimed in claim 8, wherein the detecting of input from a user by one or more input devices comprises at least one of: one or more touch-sensitive buttons, a mic, and an NFC reader.

10. The method as claimed in claim 8, wherein the generating of output via one or more output devices comprises at least a speaker for generating a voice-based output.

11. The method as claimed in claim 8, wherein the determining of an output via one or more approaches comprise one or more LLM based approaches.

12. The method as claimed in claim 11, wherein the method further comprising:
training the LLM to stimulate conversations in the voices of users.

13. The method as claimed in claim 8, wherein the method further comprising:
establishing a link to a cloud-based platform.
